(19) United States
(12) Patent Application Publication
(10) Pub. No.: US 2006/0025126 A1
(43) Pub. Date: Feb. 2, 2006

(54) Portable wireless telephone system

(76) Inventors: Priscilla M. Lu, San Carlos, CA (US); Timothy R. White, Palo Alto, CA (US)

Correspondence Address: IPSG, P.C., P.O. BOX 700640, SAN JOSE, CA, 95170-0640, US

(21) Appl. No.: 11/179,362

(22) Filed: Jul. 11, 2005

Related U.S. Application Data
(60) Provisional application No. 60/586,659, filed on Jul. 9, 2004.

(51) Int. Cl. H04Q 7/20

(52) U.S. Cl. 455/426.1

(57) ABSTRACT

The invention relates to the general field of a portable wireless communication system. In particular, the wireless communication system is designed to integrate with existing cellular communication systems and wireless local area network (LAN) systems. In one embodiment, the invention is a portable communication system that combines the advantages of the cellular wide area coverage with the low cost of WiFi Internet telephones. Advantages of the invention include the ability for portable devices to communicate with other users via both cellular and WiFi by the least expensive means possible. The result is a cost effective telecommunications network. Additional advantages include the ability to hand-over calls between cellular networks and WiFi networks. Additional advantages include true number portability since any telephone number can now be accessed via a number of different networks.

### RELATED APPLICATIONS

This application claims priority to U.S. Prov. No. 60/586,659, filed Jul. 9, 2004, incorporated herein by reference.

### FIELD

The invention relates to the general field of a portable wireless communication system. In particular, the wireless communication system is designed to integrate with existing cellular communication systems and wireless local area network (LAN) systems.

### BACKGROUND

Known portable wireless telephone systems include conventional cellular telephone systems. These cellular systems were originally designed as analog and have now been upgraded to digital systems. Digital cellular systems employ a variety of techniques and protocols for communicating with the portable phones, and locating and handing off the portable phones between base stations. In GSM cellular systems, for example, a mobile system controller (MSC) includes a home location registry (HLR) that stores information about phones that are ordinarily located in the MSC's service area. The MSC also includes a visitor location registry (VLR) that stores information about phones that are roaming in the MSC's service area. The advantage of existing cellular technology is the relatively large coverage area. The disadvantage is the relatively high cost.

Several new wireless telephone systems using IEEE 802.11 wireless protocol (WiFi) have been recently introduced into the market. The 802.11 protocol is good, but the working distance is relatively small (e.g. <300 feet). Consequently, these WiFi telephones are designed primarily for local area networks (LANs) like campus area networks or other relatively local areas where there is a lot of local telecommunication traffic. Since these telephones can also use the Internet to communicate with other users around the world, the advantage is low cost. The disadvantage is the relatively small coverage area.

What is needed is a portable telephone system that combines the advantages of the cellular wide area coverage with the low cost of WiFi Internet telephones.

### SUMMARY

The invention relates to the general field of a portable wireless communication system. In particular, the wireless communication system is designed to integrate with existing cellular communication systems and wireless local area network (LAN) systems. In one embodiment, the invention is a portable telephone system that combines the advantages of the cellular wide area coverage with the low cost of WiFi Internet telephones.

The invention comprises a server having a processor and a memory. The invention includes a first interface coupled to the Internet and a second interface coupled to a cellular network. The memory includes a database of telephone numbers and location information. In one aspect of the invention, the location information includes either a MSC or Internet Protocol (IP) address needed to communicate with the portable devices. In one aspect of the invention, the second interface is configured to communicate using interface a MAPD protocol.

Each portable device (e.g. telephone) is configured to communicate using at least one of cellular and WiFi communication protocol, and preferably both. Each device includes a unique identifier that is communicated to the database to update the location information. In one aspect of the invention, the location information is an MSC and it another aspect of the invention the location information is an IP address. In either event, the invention now knows how to contact the device by either sending a call signal to a particular MSC or to a particular IP address.

In one aspect of the invention, one of the communication techniques is preferred (e.g. WiFi) and the invention will forward calls to the subscriber via the preferred technique.

In another aspect of the invention, the mobile devices include push-to-talk capability.

Advantages of the invention include the ability for portable devices to communicate with other users via both cellular and WiFi by the least expensive means possible. The result is a cost effective telecommunications network. Additional advantages include the ability to hand-over calls between cellular networks and WiFi networks. Additional advantages include true number portability since any telephone number can now be accessed via a number of different networks.

### DRAWINGS

The invention is described with reference to the following figures.

FIG. 1 is an architectural view of a portable communication network according to an embodiment of the invention;

FIG. 2 is a view of the components of the UBQ server according to an embodiment of the invention;

FIG. 3 is a view of an exemplary information table according to an embodiment of the invention; and

FIGS. 4A-D are flowcharts showing operation on the invention for communicating between subscribers on the telecommunications network according to embodiments of the invention.

### DETAILED DESCRIPTION

The invention is described with reference to specific apparatus and embodiments. Those skilled in the art will recognize that the description is for illustration and to provide the best mode of practicing the invention. For example, references are made to devices and subscribers, while a number of portable devices can be used, for example, telephones, personal digital assistants or portable computers. Also, while reference is made to IEEE 802.11, commonly known as WiFi, this reference is intended to encompass future standards in the manner of 802.1X or others.

The invention relates to the general field of a portable wireless communication system. In particular, the wireless communication system is designed to integrate with existing cellular telephone systems and wireless local area network (LAN) systems. In one embodiment, the invention is a portable telephone system that combines the advantages of the cellular wide area coverage with the low cost of WiFi Internet telephones.

A. Architecture

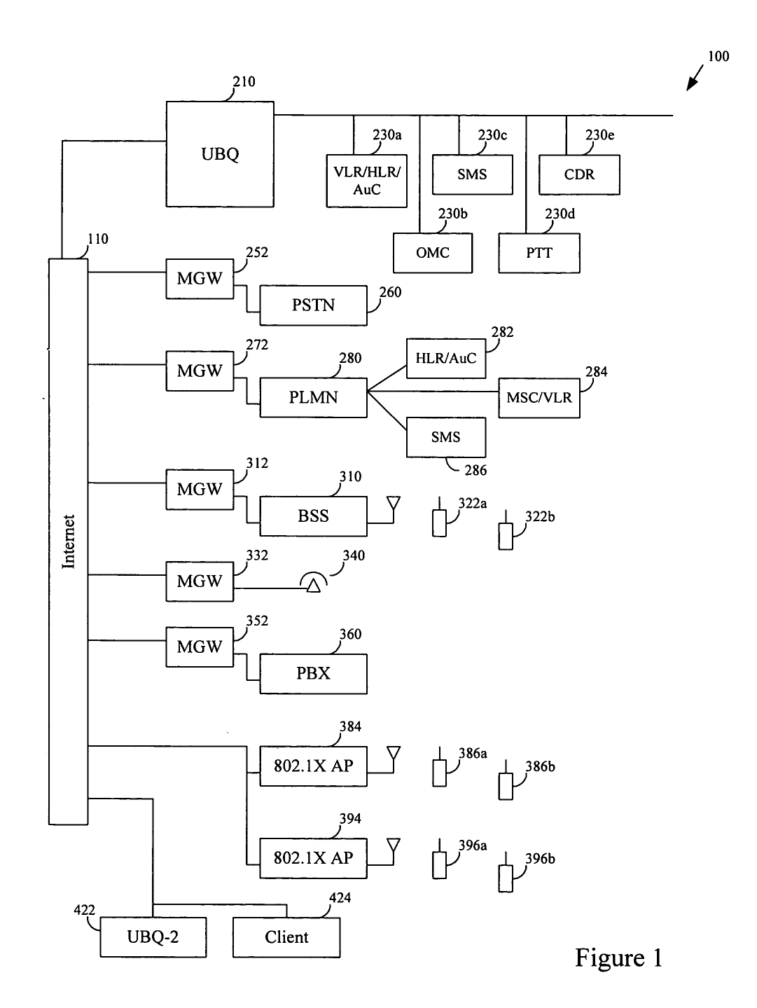

FIG. 1 is an architectural view of a portable communication network 100 according to an embodiment of the invention. The embodiment includes an Internet 110 that can be a public Internet, a private Internet or a virtual private Internet. This embodiment shows the invention integrated with a number of communication networks via media gateways (MGW). The main server and controller is a server called UBQ 210. The UBQ is coupled to a number of elements for performing its tasks of communicating with and monitoring the telephone network. For example, a VLR/HLR/AuC 230a (visitor location registry, home location registry, authentication controller), OMC 230b (network operator), SMS 230c (short message service), PTT 230d (push to talk) and CDR 230e (call detail records). Additional modules can be added as required.

A MGW 252 is coupled to a PSTN 260 (public switched telephone network) to service public switched networks. UBQ 210 communicates with MGW 252 employing standard signaling, for example, SS7, MAPD and/or other protocols as known in the art.

A MGW 272 is coupled to a PLMN 280 (public land mobile network) including a HLR/AuC 282, MSC/VLR 284 and SMS 286. This is typically coupled to standard GSM cellular networks. UBQ 210 communicates with MGW 272 employing standard signaling, for example, SS7, ISDN and/or other protocols as known in the art. Since UBQ 210 includes modules 230a-230e, which are similar to 282, 284 and 286, UBQ can store such information in case of roaming, handoff or other event that occurs in a PLMN network.

A MGW 312 is coupled to a BSS 310 (base station system) that communicates with wireless devices 322a-322b. UBQ 210 communicates with MGW 312 employing standard signaling, for example, SS7, and/or other protocols as known in the art. Since UBQ 210 includes modules 230a-230e, UBQ can store information to emulate a MSC as described above. Hence, the UBQ/BSS can perform many of the wireless communication functions of the PLMN.

A MGW 332 is configured as a residential gateway, which is often referred to as a IAD (integrated access device for voice and data over IP). MGW 322 is coupled to an exemplary wired phone 340, but can also be coupled to other devices. The MGW can also be referred to as a RGW for residential gateway.

A MGW 352 is coupled to PBX 360 (private branch exchange). UBQ 210 communicates with MGW 352 employing standard signaling, for example, ISDN and/or other protocols as known in the art.

The UBQ server 210 is also coupled to WiFi APs 384 and 394 (wireless access points). The APs communicate with wireless devices 386a-386b and 396a-396b. UBQ 210 communicates with the APs employing standard signaling, for example, Internet Protocol (IP), and/or other protocols as known in the art. The mobile devices 386a-386b and 396a-396b communicate with APs 384 and 394 using an available wireless protocol such as IEEE 802.1X. An advantage of such WiFi networks is that they are relatively inexpensive to deploy in a plurality of locations. In addition, subscribers can link up to the Internet via APs that may be located in places like airports and coffee shops, etc. throughout the world.

The UBQ server 210 can also communicate with other devices over the Internet, for example, it can be coupled to other UBQ devices 422 or client computers 424. Naturally, additional devices can be coupled to the Internet as well. UBQ 210 communicates these other devices employing standard signaling, for example, Internet Protocol (IP), and/or other protocols as known in the art.

B. UBQ Server

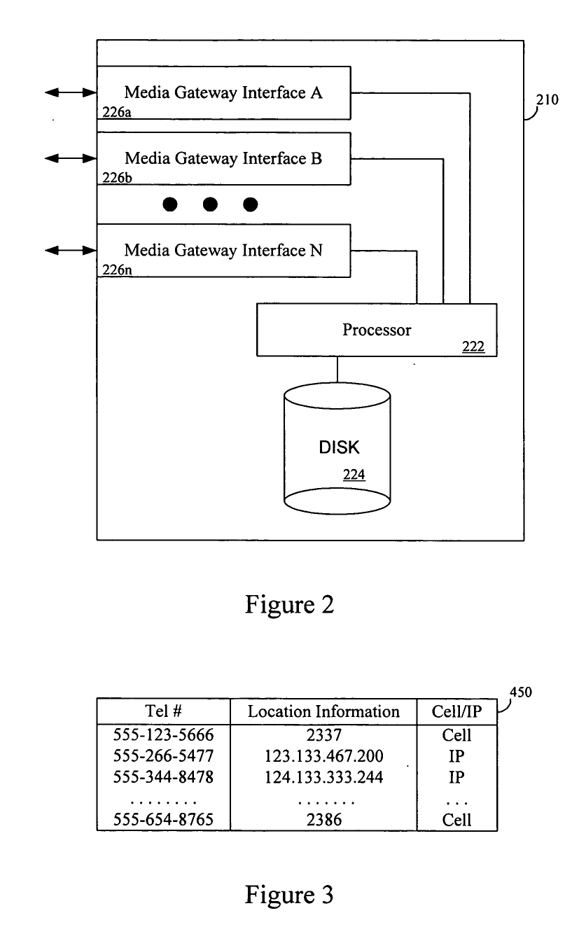

FIG. 2 is a view of the components of the UBQ server 320 according to an embodiment of the invention. The UBQ server stands for ubiquity server since it supports coordination between conventional cellular networks and other Internet telecommunications network, including PSTN networks coupled to the Internet.

The UBQ server 210 includes a processor 222 made by a manufacturer such as Intel, IBM, AMD, Sun or other manufacturer as well known in the art. A number of media gateway interfaces 226-226n are coupled to the processor and configured to communicate with the communication network as shown in FIG. 1. The protocol supported by this communication includes those protocols mentioned above with respect to communication between the UBQ and MGWs. A memory 224, for example a disk drive, is coupled to the processor to store an operating system, operating programs and data. In one aspect of the invention, the memory 224 includes a database that tracks information about each of the mobile devices in the network.

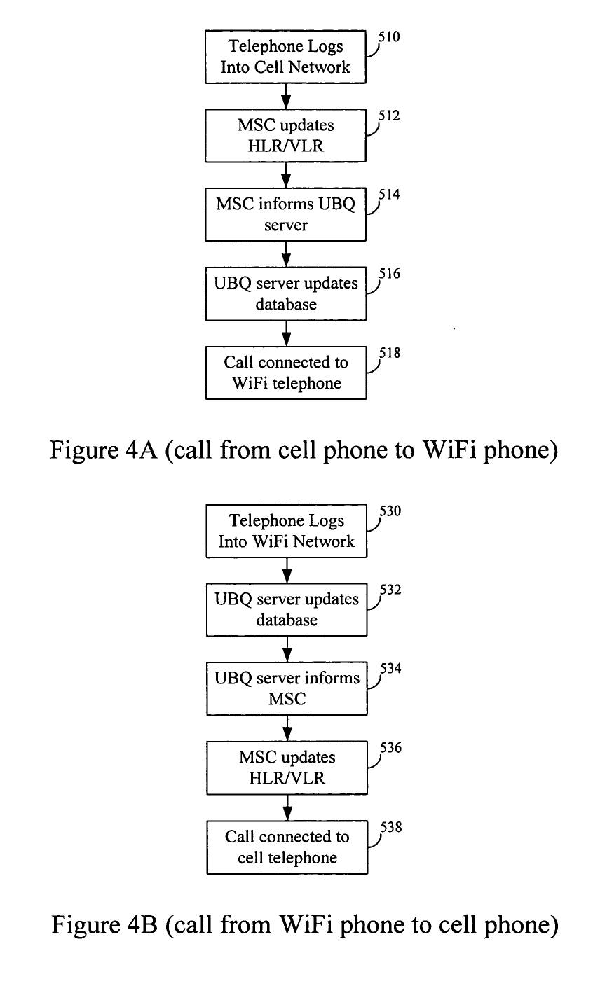

FIG. 3 is a view of an exemplary information table 450 according to an embodiment of the invention. This table 450 is part of the database stored in the memory 224. Table 450 includes information about each of the subscribing devices in the network. Table 450 also includes information similar to that stored in the MSC's HLR/VLR to support consistency in the network.

Each portable device (e.g. 322a, 386a and 396a) is configured to communicate with a base station or access point using at least one of cellular and WiFi communication protocol, and preferably both. Each device includes a unique identifier (e.g. a telephone number or media access control (MAC) address) that is communicated to the database to update the location information. When the device connects to a WiFi AP, the device receives an IP address on request using dynamic host control protocol (DHCP). The device then contacts the UBQ server, which associates the device's IP address with its unique identifier and stores that information in the database. When the UBQ server desires to send information to the device, it sends the information to the device's IP address. In some cases, the apparent IP address may be that of a router that is serving as a gateway and DHCP server with network address translation (NAT). Consequently, while the device's IP address may be a local one (i.e. 192.168.*.*), the router can correctly direct the information to the device because the router stores the NAT information.

When a device logs into the cellular network (e.g. PLMN 280) the MSC updates its HLR/VLR to acknowledge that the device is in its network. If the device's home is the UBQ network, the MSC informs the UBQ server via MAPD to direct calls to the MSC.

When a device logs into the WiFi network (e.g. APs 384 and 294), the UBQ server updates its database to acknowledge that the device is in its network. If the device's home is the cellular network, the UBQ server informs the MSC to update its HLR/VLR to direct calls to the UBQ server.

In one aspect of the invention, the location information is an MSC and in another aspect of the invention the location information is an IP address. In either event, once the device is logged into a respective network, the invention knows how to contact the device by either sending the call to a particular MSC or to a particular IP address.

In one aspect of the invention, one of the communication techniques is preferred (e.g. WiFi) and the invention will forward calls to the subscriber via the preferred technique.

A conventional PSTN network 260 is shown connected to the UBQ server. If a conventional wired device (e.g. telephone) wants to call a wireless device (e.g. 322a, 386a and 396a), a registry 262 informs the PSTN network to forward the call over the Internet to the UBQ server. If a conventional phone user wants to forward his calls to a mobile phone, he can set the registry 262 to forward calls to the mobile phone via the UBQ server.

C. Operational Flowcharts

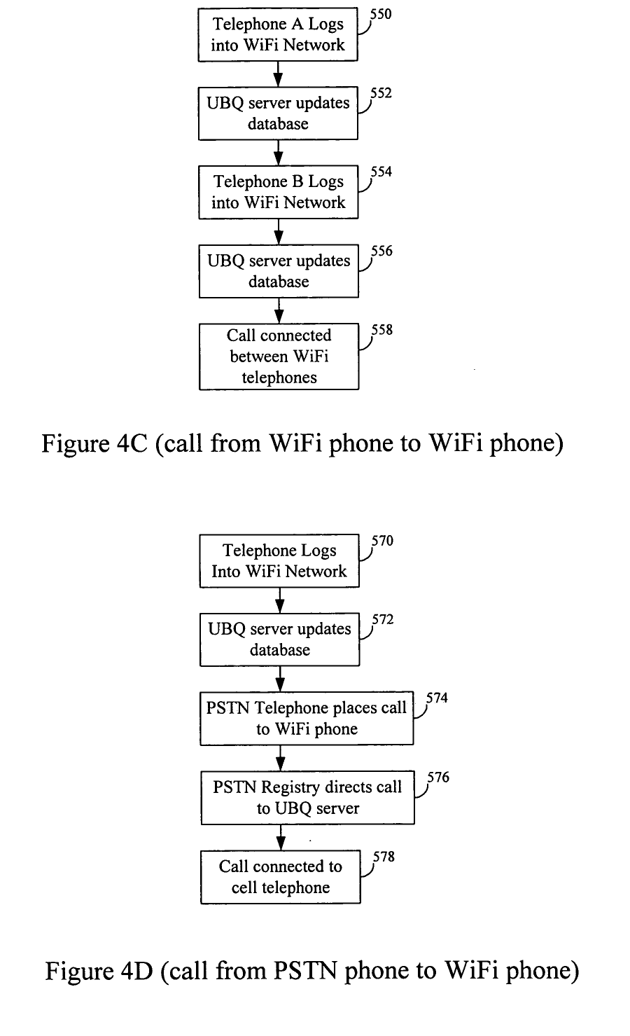

FIGS. 4A-D are flowcharts showing operation on the invention for communicating between subscribers on the telecommunications network according to embodiments of the invention.

### D. CONCLUSION

Advantages of the invention include the ability for portable devices to communicate with other users via both cellular and WiFi by the least expensive means possible. The result is a cost effective telecommunications network. Additional advantages include the ability to hand-over calls between cellular networks and WiFi networks. Additional advantages include true number portability since any telephone number can now be accessed via a number of different networks.

Having disclosed exemplary embodiments and the best mode, modifications and variations may be made to the disclosed embodiments while remaining within the subject and spirit of the invention as defined by the following claims.

1. A portable communication system comprising:
a processor;
a memory coupled to the process and configured to store a database including portable telephone subscriber information and location information;
a plurality of media gateway interfaces configured to communicate with a plurality of media gateways, wherein at least one media gateway is an Internet gateway and at least one media gateway is a cellular gateway.

2. The portable communication system of claim 1, wherein:
the database includes information regarding telephone numbers and IP addresses.

3. The portable communication system of claim 2, wherein:
the processor is configured to update the database when a new subscriber enters a service area.

4. The portable communication system of claim 1, wherein:
the second interface is configured to communicate in a MAPD protocol.

5. The portable communication system of claim 1, wherein:
the second interface is configured to respond to MAPD requests for the location of subscribers.

6. The portable communication system of claim 1, further comprising:
a telephone including a transceiver configured to selectively communicate over a cellular network or WiFi network and including a setting for indicating a preferred communication technique.

7. The portable communication system of claim 1, wherein:
at least one media gateway is a PSTN gateway.
